(19) United States
(12) Patent Application Publication
(10) Pub. No.: US 2017/0046310 A1
(43) Pub. Date: Feb. 16, 2017

(54) PROVIDING SEMANTIC BASED DOCUMENT DESIGN

(71) Applicant: MICROSOFT TECHNOLOGY LICENSING, LLC, Redmond, WA (US)

(72) Inventors: Ruth Kikin-Gil, Redmond, WA (US); Michelle Keslin, Kirkland, WA (US)

(21) Appl. No.: 14/825,083

(22) Filed: Aug. 12, 2015

(51) Int. Cl. G06F 17/21; G06F 17/24; G06F 3/0484; G06F 3/0485; G06F 3/0482; G06F 3/0483

(52) U.S. Cl. CPC G06F 17/212; G06F 3/0482; G06F 3/0483; G06F 3/04842; G06F 3/04847; G06F 17/214; G06F 3/0485; G06F 17/24

(57) ABSTRACT

A semantic based design may be provided for a document. An application, such as a document processing application, generates previews of the document and presents the previews of the document on a user interface (UI) displayed on a display device. A selection of a preview from the previews is detected. A semantic style associated with the selected preview is applied to the document. The semantic style includes formatting configurations to be applied to the document. In response to detecting a save operation on the document, the semantic style associated with the selected preview is saved.

### BACKGROUND

A user may interact with a document processing application through a user interface of a computing device. The document processing application may allow the user to select a theme to apply to a document. The theme may include formatting configurations. The formatting configurations may include, among others, a style of textual content in the document, a font size of the textual content, spacing associated with the textual content, a color scheme associated with the textual content, and a page layout of the document. Once the theme is selected, the document processing application may apply the theme to an entirety of the document.

The document processing application may allow the user to edit the formatting configurations of the theme, as it may be difficult to predict formatting of objects in the document from the theme selection. Additionally, it may be difficult to format the document on the computing device having a smaller sized user interface (UI). Further, the document processing application may allow multiple users to edit different sections in the document. This, however, may lead to an inconsistent formatting scheme throughout the document.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a semantic based design for a document. In some examples, a document processing application may generate previews of a document. The previews of the document may be presented on a user interface (UI) displayed on the display device. A selection of a primary preview from the previews may be detected. A primary semantic style associated with the primary preview may be applied to the document. The primary semantic style may include formatting configurations to be applied to the document. The primary semantic style associated with the primary preview may be saved in response to a detection of a save operation on the document.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating a system to provide semantic based document design, according to embodiments;

FIG. 2 is a display diagram illustrating example navigation actions between previews of the document, according to embodiments:

FIG. 3A and FIG. 3B are display diagrams illustrating an example font customization action to modify a primary preview of a document, according to embodiments;

FIG. 4A and FIG. 4B are display diagrams illustrating an example color customization action to modify a primary preview of a document, according to embodiments;

FIG. 5A and FIG. 5B are display diagrams illustrating an example spacing customization action to modify a primary preview of a document, according to embodiments;

FIG. 6 is a simplified networked environment, where a system according to embodiments may be implemented:

FIG. 7 is a block diagram of an example computing device, which may be used to provide a semantic based design for a document; and

FIG. 8 is a logic flow diagram illustrating a process for providing a semantic based design for a document, according to embodiments.

### DETAILED DESCRIPTION

As briefly described above, a semantic based design may be provided for a document by a document processing application. The document processing application may generate previews of a document. The previews may be displayed on a user interface (UI) of the document processing application. A selection of a primary preview from the previews may be detected. A primary semantic style associated with the primary preview may be applied to the document. The primary semantic style may include formatting configurations to be applied to the document. The primary semantic style associated with the primary preview may be saved in response to a detection of a save operation on the document. The document processing application may render the primary semantic style within the primary preview.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide a semantic design for a document. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

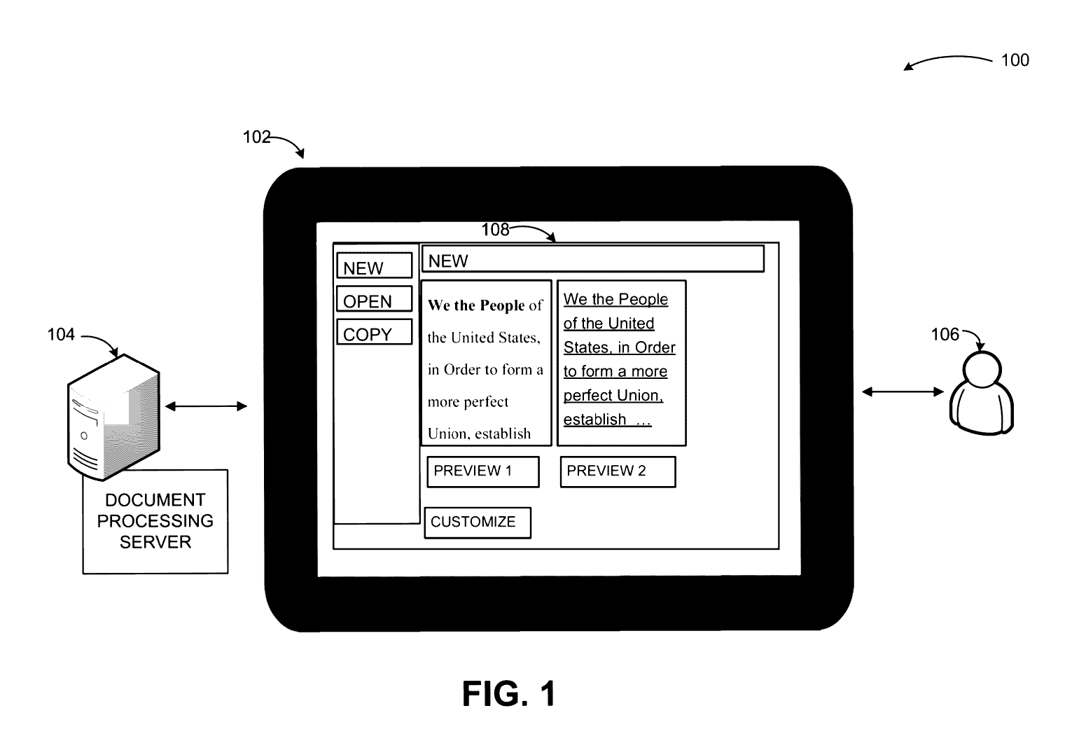

FIG. 1 is a conceptual diagram illustrating a system to provide semantic based document design, according to embodiments.

In a diagram 100, a computing device 102 may execute a document processing application 108. The computing device 102 may include a tablet device, a laptop computer, a desktop computer, and a smart phone, among others. The computing device 102 may include a display device, such as a touch enabled display component and a monitor, among others, to provide a user interface (UI) of the document processing application 108 to the user 106. The user 106 may be allowed to interact with the document processing application 108 through an input device or a touch enabled display component of the computing device 102.

The document processing application 108 may generate previews of the document and may display the previews on a user interface (UI) of the display device. The previews may display content of the document through use of varying semantic styles. For example, a primary preview from the previews may display a primary semantic style associated with the content of the document. The document processing application 108 may render the primary semantic style within the preview. A secondary preview from the previews may display a secondary semantic style associated with the content of the document.

The UI may include a toolbar control. The toolbar control may include toolbar commands with operations to format the document. The toolbar control may be displayed in a position within a proximity to the previews. The position may include, among others, below the previews, above the previews, to a left side from the previews, and to a right side from the previews.

The user 106 may interact with the document processing application 108 with a keyboard based input, a mouse based input, a voice based input, a pen based input, and a gesture based input, among others. The gesture based input may include, for example, touch based actions such as a touch action, a swipe action, and a combination of each, among others. The document processing application 108 may receive a selection of the primary preview from the user 106.

The document processing application 108 may render the primary semantic style within the primary preview. The primary semantic style may include formatting configurations that may be applied to the document. The primary preview may be presented on the UI of the document processing application 108 displayed on the display device. In additional examples, the document processing application 108 may detect a save operation on the document to persist the primary semantic style associated with the primary preview.

The document processing application 108 may store the document locally. Alternatively, the document may be retrieved from a document processing service hosted by a document processing server 104. The computing device 102 may communicate with the document processing server 104 through a network. The network may provide wired or wireless communications between nodes, such as the computing device 102 or the document processing server 104, among others.

While the example system in FIG. 1 has been described with specific components including the computing device 102 and the document processing application 108. Embodiments are not limited to these components or system configurations and can be implemented with other system configuration employing fewer or additional components. For example, the document processing application 108 may include a formatting module that may be configured to perform all or some of the operations executed by the document processing application 108.

As discussed herein, the application may be employed to perform operations associated with providing the semantic design for the document. An increased user efficiency with the document processing application 108 may occur as a result of a display of the content in the previews, and application of those previews to achieve consistent formatting among document sections and users. Additionally, detecting and executing a selection of toolbar commands to modify the document, application of preview styles to document content, and other operations of the document processing application 108 may reduce processor load, increase processing speed, conserve memory, and reduce network bandwidth usage.

Embodiments, as described herein, address a need that arises from a lack of efficiency between the user 106 interacting with the document processing application 108 of the computing device 102. The actions/operations described herein are not a mere use of a computer, but address results that are direct consequences of software used as a service offered to large numbers of users and applications.

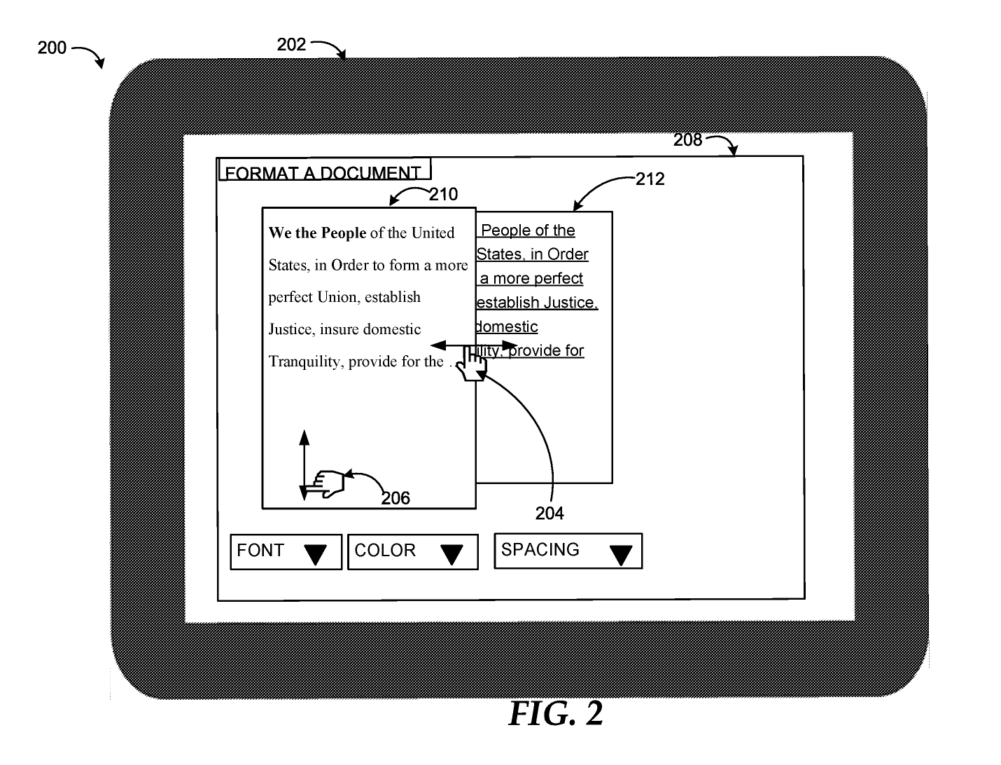

FIG. 2 is a display diagram illustrating example navigation actions between previews of the document, according to embodiments. For example, a user may scroll, flip, or otherwise navigate between previews of the document to view the document in one or more of the previewed semantic styles. While FIG. 2 is described with reference to scroll actions, the disclosure is not limited thereto.

In a diagram 200, a computing device 202 may display a document processing application 208. A document may be presented on a UI of the document processing application 208. The document processing application 208 may generate a primary preview 210 and one or more secondary previews 212 of the document. The primary preview 210 and the secondary previews 212 may be displayed on the display device. In some examples, the primary preview 210 and the secondary previews 212 may be displayed as a slideshow presentation. In additional examples, the document processing application 208 may detect a save operation on the document to persist the primary semantic style associated with the primary preview 210.

In an example, the document processing application 208 may generate the previews based on a historical formatting selection associated with the document. For example, the document processing application 208 may receive a selection of the primary preview 210 from the user during a time period. The document processing application 208 may render the primary semantic style within the primary preview 210 during the time period. During a subsequent time period, the document processing application 208 may receive an action to edit another document from the user. This subsequent document may or may not be related (e.g., in subject matter and/or format) to the previous document, but the document processing application 208 may apply the primary semantic style to primary preview 210 of the subsequent document. The document processing application may render the primary semantic style within the preview.

In other embodiments, the document processing application 208 may generate the previews based on formatting selections associated with a set of application-generated templates, historical selections of other users, and/or in another suitable manner.

The document processing application 208 may detect a selection of the toolbar commands to modify the document or a section thereof. The toolbar commands may include customization actions. The customization actions may include, among others, a font customization of the document, a spacing customization of the document, and/or a color customization of the document. The document processing application 108 may execute the customization actions associated with the selected toolbar commands to modify the primary preview 210.

The document processing application 208 may receive a selection of the primary preview 210 from the user. In an example, a first page of a document may be displayed on the primary preview 210. The document processing application 208 may detect a vertical scroll action 206 on the primary preview 210 and may replace the first page of the document with a second page of the document. The document processing application 208 may display the second page of the document in a user interface (UI) of the display device.

In another example, the document processing application 208 may detect a horizontal scroll action 204 that starts within the primary preview 210 and ends within the displayed bounds of one of the secondary previews 212. The primary preview 210 may be replaced on the UI of the display device with the associated secondary preview 212. In a further example, the document processing application 208 may detect a direct selection of the secondary preview 212 by the user, for example, by a click, tap, or other action on the secondary preview. In response, the document processing application 208 may display the selected secondary preview 212 on the UI of the display device. The document processing application 208 may further detect a selection action to mark the secondary preview 212 as a favorite preview, such as by selection of an icon (e.g., star) or other option (not shown) associated with the preview, a particular click, tap, or other action sequence (e.g., double-tap), or in another suitable manner. The selection action to mark the secondary preview 212 as the favorite preview may promote use of the secondary preview 212 in a future edit session by emphasizing the favorite preview. The favorite preview may be emphasized through use of fonts and color schemes, among other methods.

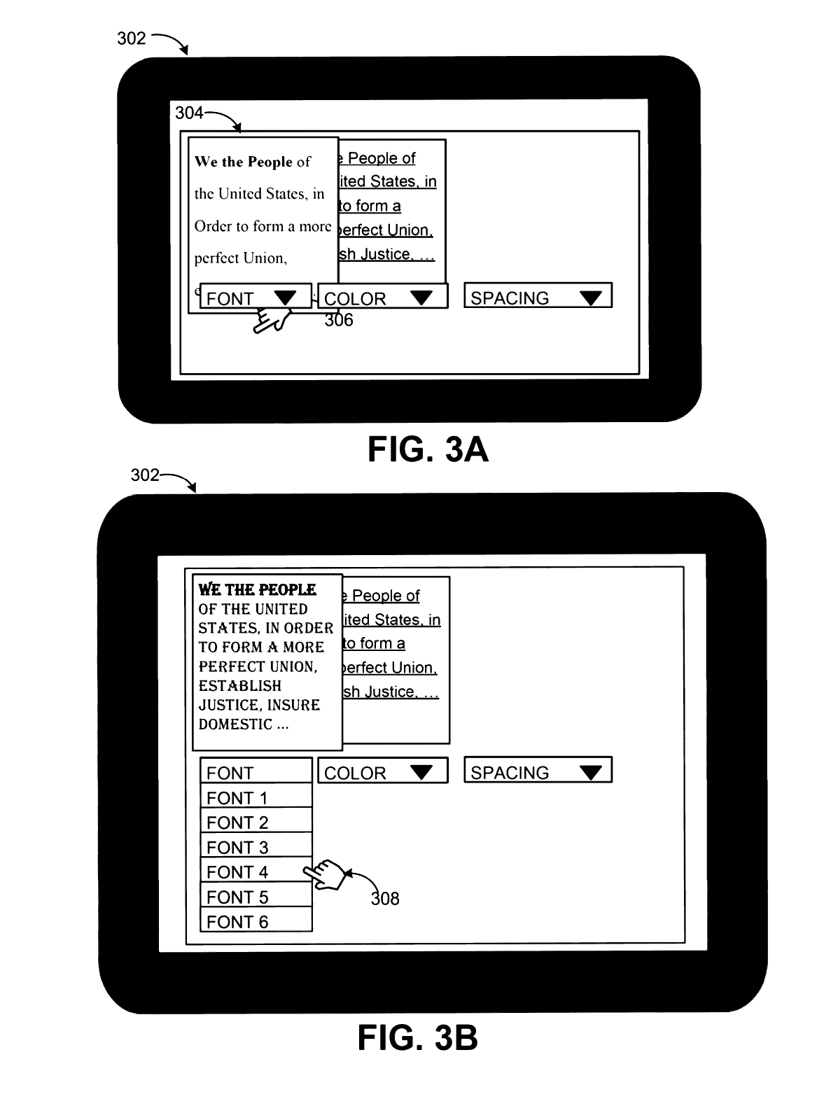

FIG. 3A and FIG. 3B are display diagrams illustrating an example font customization action to modify a primary preview of a document, according to embodiments.

In FIG. 3A, a computing device 302 may display a document processing application 304. The computing device 302 may include a display device that may provide a user interface (UI) of the document processing application 304 to the user. The document processing application 304 may generate the primary preview and one or more secondary previews of the document, as described herein.

The document processing application 304 may receive a selection of the primary preview from the user. The document processing application 304 may render a primary semantic style within the primary preview. The document processing application may display the primary preview on a user interface (UI) of the display device. The UI may include a toolbar control. The toolbar control may display toolbar commands 306. The toolbar commands 306 may include a customization action to modify formatting of the content in the document or a section thereof.

In FIG. 3B, the document processing application 304 may detect a selection 308 of one or more of the toolbar commands 306 to modify the formatting of the content in the document. The formatting may include, among others, a style of textual content and/or a font size of the textual content of the document. The document processing application 304 may execute the customization action associated with the selected toolbar commands to modify the document. The document processing application 304 may display the modified formatting in the primary preview. In additional examples, the document processing application 304 may detect a save operation (not shown) on the document to persist the formatting associated with the primary preview.

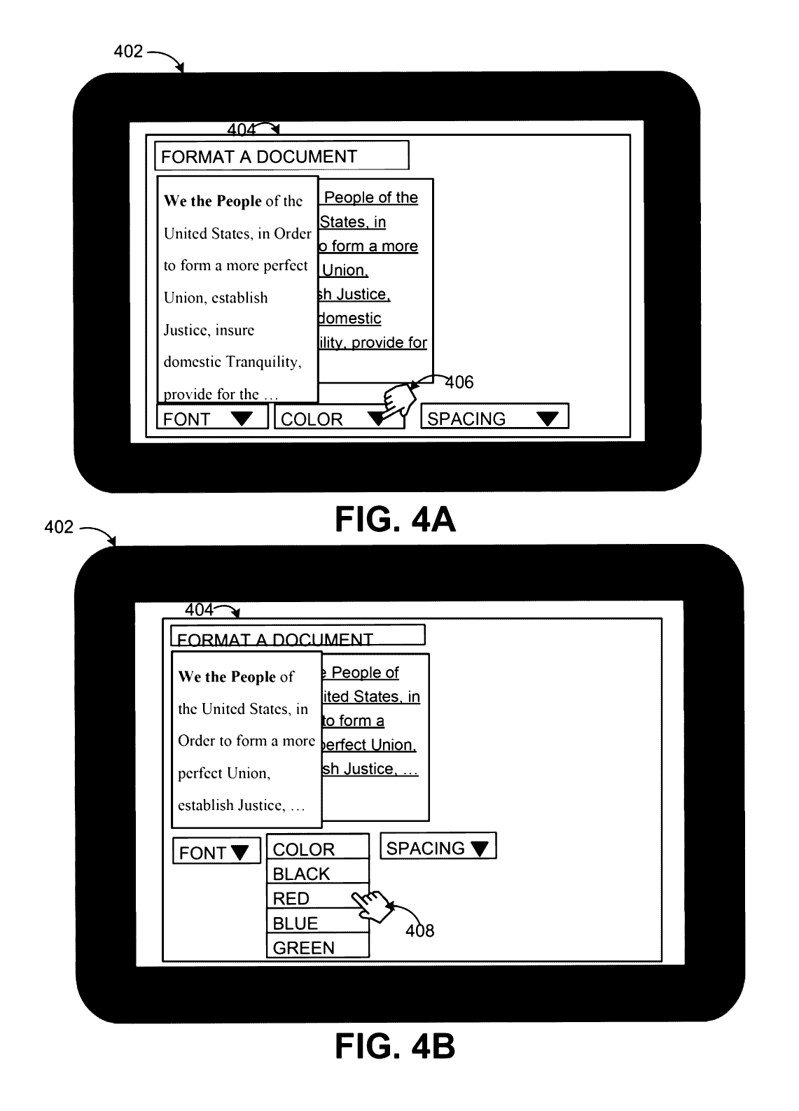

FIG. 4A and FIG. 4B are display diagrams illustrating an example color customization action to modify a primary preview of a document, according to embodiments.

In FIG. 4A, a computing device 402 may display a document processing application 404. The computing device 402 may include a display device that may provide a user interface (UI) of the document processing application 404 to the user. The document processing application 404 may receive a request to perform an action to edit a document from the user. The document processing application 404 may generate the primary preview and one or more secondary previews of the document.

The document processing application 404 may receive a selection of the primary preview from the user. The document processing application 404 may render a primary semantic style within the primary preview. The document processing application 404 may display the primary preview on a user interface (UI) of the display device. The UI of the display device may include a toolbar control. The toolbar control may display toolbar commands 406. The toolbar commands 406 may include customization actions to modify the content in the document or a section thereof.

In FIG. 4B, the document processing application 404 may detect a selection 408 of one or more of the toolbar commands 406 to modify the formatting of the content in the document. The formatting may include, among others, a color scheme of the content in the document. The document processing application 404 may execute the customization action associated with the selected toolbar commands 406 to modify the formatting of the document. The document processing application 404 may display the modified formatting in the primary preview. In additional examples, the document processing application 404 may detect a save operation (not shown) on the document to persist the primary semantic style associated with the modified formatting.

In an example, the document processing application 404 may generate a secondary semantic style from attributes of an image within the content. The attributes of the image may include, among others, a predominant color within the image and/or a logo associated with the image. The document processing application 404 may apply the secondary semantic style to the primary preview. The document processing application 404 may render the primary semantic style within the primary preview. In additional examples, the document processing application may detect a save operation (not shown) on the document to persist the primary semantic style associated with the primary preview.

In another example, the document processing application 404 may detect a request to perform a lock action on formatting of the content, such as by selection of an icon (e.g., padlock) or other option (not shown) associated with the preview, a particular click, tap, or other action sequence, or in another suitable manner. The lock action may be executed on the primary preview. Due to the execution of the lock action, the user may browse other formatting options of the primary preview and/or a secondary preview without losing the locked formatting.

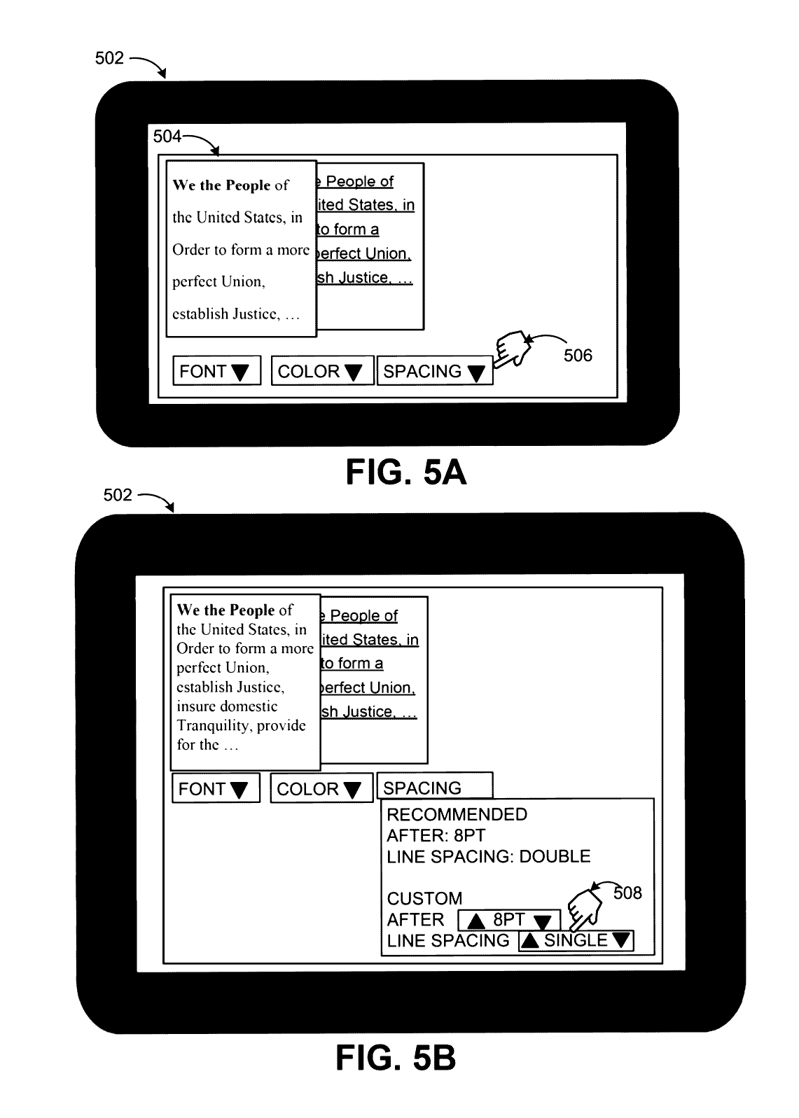

FIG. 5A and FIG. 5B are display diagrams illustrating an example spacing customization action to modify a primary preview of a document, according to embodiments.

In FIG. 5A, a computing device 502 may display a document processing application 504. The computing device 502 may include a display device that may provide a user interface (UI) of the document processing application 504 to the user. The document processing application 504 may receive a request to perform an action to edit a document from the user. The document processing application 504 may generate the primary preview and one or more secondary previews of the document.

The document processing application 504 may receive a selection of the primary preview from the user. The document processing application 504 may render a primary semantic style within the primary preview. The document processing application may display the primary preview on a user interface (UI) of the display device. The UI of the display device may include a toolbar control. The toolbar control may display toolbar commands 506. The toolbar commands 506 may include customization actions to modify the content in the document or a section thereof.

In FIG. 5B, the document processing application 504 may detect a selection 508 of the toolbar commands 506 to modify the formatting of the content in the document. The formatting may include, among others, a spacing customization between text in the document and/or a spacing customization between paragraphs in the document. The document processing application 504 may execute the customization action associated with the selected toolbar commands 506 to modify the formatting of the document. The document processing application 504 may display the modified formatting in the primary preview. In additional examples, the document processing application may detect a save operation (not shown) on the document to persist the primary semantic style associated with the modified formatting.

The example scenarios and schemas in FIG. 1 through FIG. 5B are shown with specific components, data types, and configurations. Embodiments are not limited to systems according to these example configurations. Providing the semantic design for the document may be implemented in configurations employing fewer or additional components in applications and user interfaces. For example, the document processing application 504 may include a formatting module and a rendering module to perform the operations executed by the document processing application 504. Furthermore, the example schema and components shown in FIG. 1 through FIG. 5B and their subcomponents may be implemented in a similar manner with other values using the principles described herein.

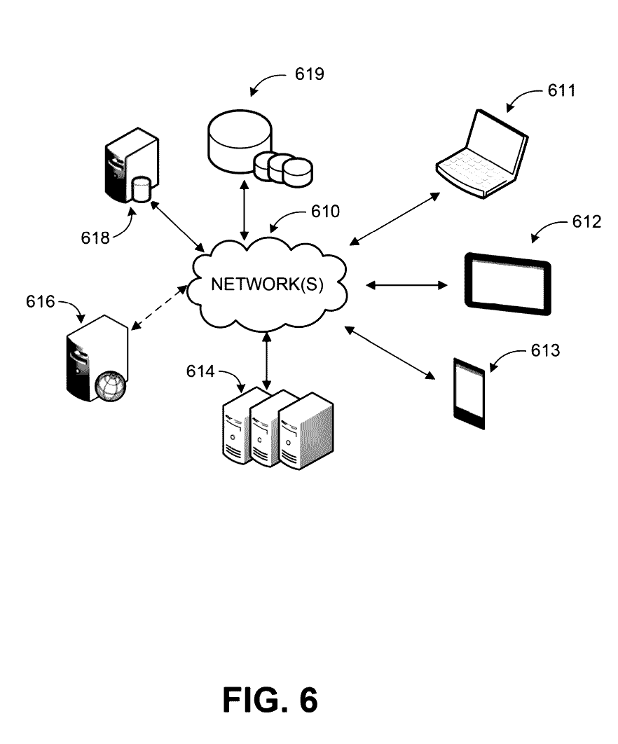

FIG. 6 is a simplified networked environment, where a system according to embodiments may be implemented.

A document processing application may be configured to provide a semantic design for a document. Operations performed by the document processing application may be implemented via software executed over one or more servers 614, such as a hosted document processing service. The operations performed by the document processing application may alternatively be implemented via a formatting module of the document processing application. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. The document processing application may detect an action to edit the document. Previews of the document may be generated. The previews of the document may be presented on a user interface (UI) displayed on the display device. A selection of a primary preview from the previews may be detected. A primary semantic style associated with the primary preview may be applied to the document. The primary semantic style includes formatting configurations to be applied to the document. In response to detecting a save operation on the document, the primary semantic style associated with the primary preview may be saved. The document processing application may store data associated with the content of the document in data store(s) 619 directly or through database server 618.

Network(s) 610 may comprise any topology of servers, clients, Internet service providers, and communication media. A system according to embodiments may have a static or dynamic topology. The network(s) 610 may include secure networks such as an enterprise network, an unsecure network such as a wireless open network, or the Internet. The network(s) 610 may also coordinate communication over other networks such as Public Switched Telephone Network (PSTN) or cellular networks. Furthermore, the network(s) 610 may include short range wireless networks such as Bluetooth or similar ones. The network(s) 610 provide communication between the nodes described herein. By way of example, and not limitation, the network(s) 610 may include wireless media such as acoustic, RF, infrared and other wireless media.

Many other configurations of computing devices, applications, data sources, and data distribution systems may be employed for providing the semantic design for the document. Furthermore, the networked environments discussed in FIG. 6 are for illustration purposes only. Embodiments are not limited to the example applications, modules, or processes.

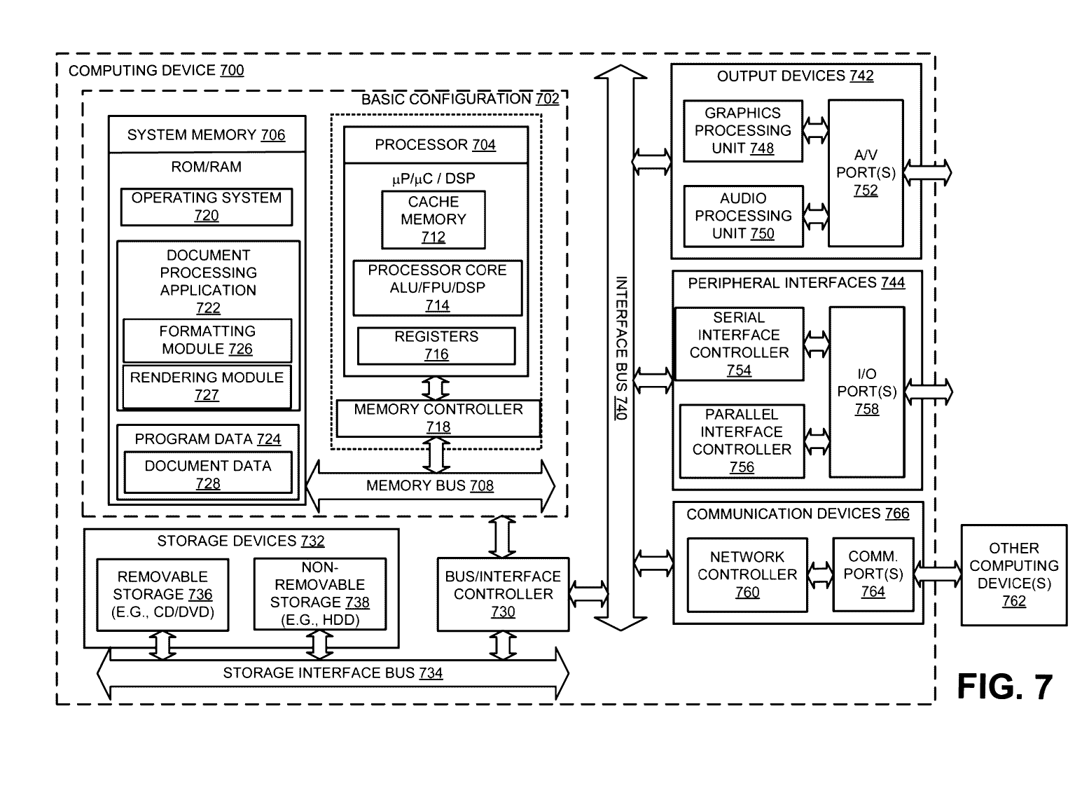

FIG. 7 is a block diagram of an example computing device, which may be used to provide a semantic based design for a document, according to embodiments.

For example, a computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The example basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The one or more processor cores 714 may (each) include an arithmetic logic unit (ALU), a floating point unit (FPU), a digital signal processing core (DSP Core), or any combination thereof. An example memory controller 718 may also be used with the processor 704, or in some implementations the example memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a document processing application 722, and a program data 724. The document processing application 722 may include a formatting module 726 and a rendering module 727, among other modules. The rendering module 727 may be configured to generate previews of a document and present the previews of the document on a user interface (UI) displayed on the display device. The formatting module 726 may be configured to detect a selection of a primary preview from the previews and apply a primary semantic style associated with the primary preview to the document. The primary semantic style includes formatting configurations to be applied to the document. In response to detecting a save operation on the document, the formatting module 726 may be configured to save the primary semantic style associated with the primary preview.

Components of the document processing application 722 (such as a user interface) may also be displayed on a display device associated with the computing device 700. An example of the display device may include a hardware screen that may be communicatively coupled to the computing device 700. The display device may include a touch based device that detects gestures such as a touch action. The display device may also provide feedback in response to detected gestures (or any other form of input) by transforming a user interface of the document processing application 722, displayed by the touch based device. The program data 724 may also include, among other data, a document data 728, or the like, as described herein. The document data 728 may include semantic data such as formatting configurations that may be applied to the document displayed on the computing device 700, among others.

The computing device 700 may have additional features or functionality, and additional interfaces to facilitate communications between the example basic configuration 702 and any desired devices and interfaces. For example, a bus/interface controller 730 may be used to facilitate communications between the example basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology. CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the example basic configuration 702 via the bus/interface controller 730. Some of the one or more output devices 742 include a graphics processing unit 748 and an audio processing unit 750, which may be configured to communicate to various external devices such as a display or speakers via one or more A/V ports 752. The one or more peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer, which includes any of the above functions. The computing device 700 may also be implemented as a personal computer including both laptop computer and non-laptop computer configurations.

Example embodiments may also include methods to provide a semantic design for a document. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

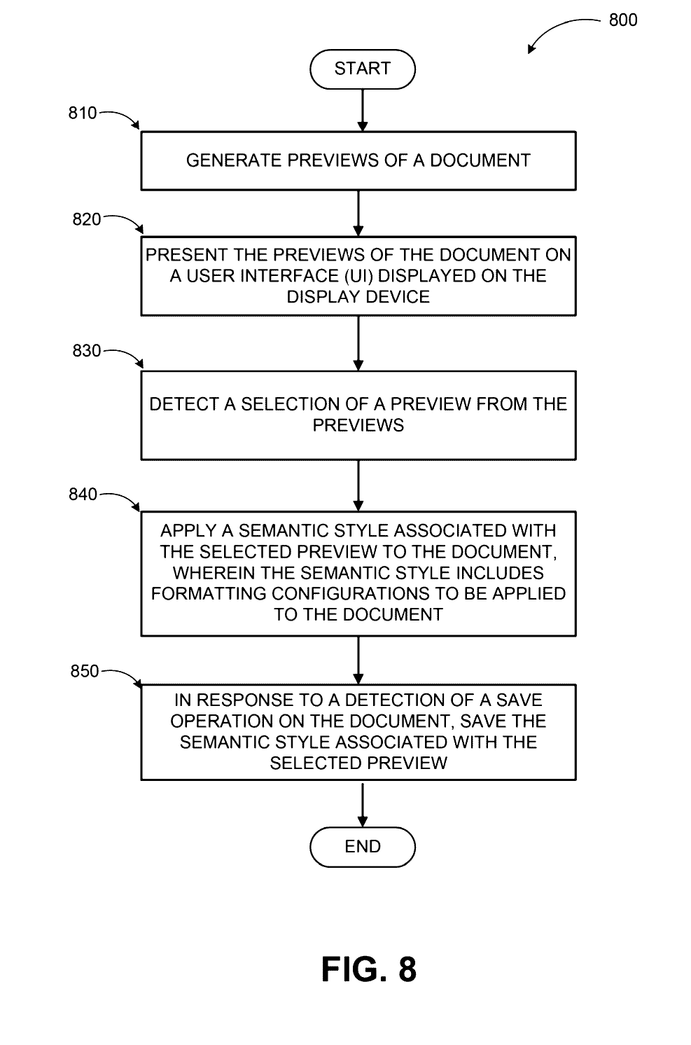

FIG. 8 is a logic flow diagram illustrating a process for providing a semantic based design for a document, according to embodiments.

Process 800 may be implemented on a computing device, such as the computing device 700, or another system. As described, a user may be allowed to interact with a document processing application through an input device or a touch enabled display component of the computing device 700. The computing device 700 may include a display device to provide a user interface (UI) of the document processing application to the user. The UI may include a toolbar control.

Process 800 begins with operation 810, where previews of a document may be generated by the document processing application. The previews may include a primary preview and one or more secondary previews, among others. The primary preview may include a primary semantic style. The secondary preview(s) may include secondary semantic style(s). In some examples, before the document is created, the primary preview may be generic, such as provided based on a user-agnostic template and/or including filler text. After creation of the document, the primary preview may display content of the document. At operation 820, the previews of the document may be presented on a user interface (UI) displayed on a display device. The toolbar control of a user interface (UI) on the display device may display toolbar commands. The toolbar control may be displayed in a position within a proximity to the previews.

At operation 830, a selection of the primary preview from the previews may be detected. At operation 840, the primary semantic style associated with the primary preview may be applied to the document. The primary semantic style may include formatting configurations to be applied to the document.

At operation 850, a save operation may be detected on the document to save the primary semantic style associated with the primary preview, such as by selection of an icon (e.g., disk) or other option (not shown) associated with the preview, a particular click, tap, or other action sequence, or in another suitable manner. In other examples, the document processing application 108 may render the primary semantic style within the primary preview. Once the primary preview is displayed on the UI, the document processing application may detect a selection of the toolbar commands to modify the document. The toolbar commands may include customization actions. The customization actions may include, among others, a font customization of the document, a spacing customization of the document, and/or a color customization of the document. The document processing application may execute the customization actions associated with the selected toolbar commands to modify the formatting.

The operations included in process 800 are for illustration purposes. Providing the semantic based design for the document may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to embodiments, a computing device to provide a semantic based design for a document may be described. The computing device may include a display device, a memory configured to store instructions associated with a document processing application, and one or more processors coupled to the memory and the display device. The one or more processors may execute the document processing application in conjunction with the instructions stored in the memory. The document processing application may include a rendering module and a formatting module. The rendering module may be configured to generate previews of a document and present the previews of the document on a user interface (UI) displayed on the display device. The formatting module may be configured to detect a selection of a primary preview from the previews and apply a semantic style associated with the primary preview to the document. The formatting module may also be configured to save the semantic style associated with the primary preview in response to a detection of a save operation on the document. The semantic style may include formatting configurations to be applied to the document.

According to other examples, the formatting module may be further configured to display a toolbar control in a position within a proximity to the previews. The toolbar control may include toolbar commands. The formatting module may be further configured to detect a selection of a first command from the toolbar commands to modify the document and execute operations associated with the first command to modify the primary preview. The position may include one of: below the previews, above the previews, to a left side from the previews, and to a right side from the previews.

According to some embodiments, the formatting module may be further configured to detect a scroll action on the primary preview, where a page of the document is displayed on the primary preview. The formatting module may also replace the page of the document displayed on the primary preview with another page of the document. In further embodiments, the formatting module may be configured to detect a scroll action that starts within the primary preview and ends within a secondary preview from the previews and replace the primary preview on a user interface (UI) of the display device with the secondary preview.

According to additional embodiments, the formatting module may be further configured to detect a selection of the secondary preview from the previews, apply a secondary semantic style associated with the secondary preview to the document, and display the secondary preview on a user interface (UI) of the display device. The formatting module may also be configured to detect a customization action to modify the document and modify the secondary preview to match the customization action. The customization action may include one or more of: a font customization of the document, a spacing customization of the document, and a color customization of the document.

According to some embodiments, the formatting module may be further configured to detect a selection action to mark the primary preview as a favorite preview, where the selection action promotes use of the favorite preview in a future edit session. The formatting module may also be configured to display the previews of the document as a slideshow presentation.

According to some examples a means to provide a semantic based design for a document may be described. The means to provide the semantic based design for the document may include a means to generate previews of a document, a means to present the previews of the document on a user interface (UI) displayed on the display device, a means to detect a selection of a primary preview from the previews, a means to apply a semantic style associated with the primary preview to the document, and a means to save the semantic style associated with the primary preview in response to a detection of a save operation on the document.

According to additional embodiments, the means to provide the semantic based design for the document may additionally include a means to generate a secondary semantic style from attributes of an image within the document. The attributes of the image may include a predominant color within the image. The means to provide the semantic based design for the document may additionally include a means to apply the secondary semantic style to the document in the primary preview and a means to display the primary preview with the secondary semantic style in a user interface (U) of the display device.

According to additional embodiments, the means to provide the semantic based design for the document may additionally include a means to detect a formatting selection in response to an activation of a formatting control, a means to generate a secondary semantic style based on the formatting selection, a means to apply the secondary semantic style to the document in the primary preview, and a means to display the primary preview with the secondary semantic style in a user interface (UI) of the display device.

According to some embodiments, the means to provide the semantic based design for the document may additionally include a means to detect a scroll action that starts within the primary preview and ends within the secondary preview. The secondary preview may display the secondary semantic style. The means to provide the semantic based design for the document may additionally include a means to replace the primary preview on the UI of the display device with the secondary preview.

In further examples, the means to provide the semantic based design for the document may additionally include a means to generate the previews based on historical formatting selections associated with the document. The means to provide the semantic based design for the document may additionally include a means to generate the previews based on historical formatting selections associated with one or more documents related to the document.

According to some examples, a computer-readable memory device with instructions stored thereon to provide a semantic based design for a document may be described. The instructions may include actions that are similar to the method described above.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device configured to provide a semantic based document design for a document, wherein the computing device comprises:
a display device;
a memory configured to store instructions associated with a document processing application; and
one or more processors coupled to the memory and the display device, the one or more processors executing the document processing application in conjunction with the instructions stored in the memory, wherein the document processing application includes:
a rendering module configured to:
generate previews of the document;
present the previews of the document on a user interface (UI) displayed on the display device;
a formatting module configured to:
detect a selection of a preview from the previews;
apply a semantic style associated with the selected preview to the document, wherein the semantic style includes formatting configurations to be applied to the document; and
in response to a detection of a save operation on the document, save the semantic style associated with the selected preview.

2. The computing device of claim 1, wherein the formatting module is further configured to:
display a toolbar control in a position within a proximity to the previews, wherein the toolbar control includes toolbar commands.

3. The computing device of claim 2, wherein the formatting module is further configured to:
detect a selection of a first command from the toolbar commands to modify the document; and
execute operations associated with the first command to modify the selected preview.

4. The computing device of claim 2, wherein the position includes one of: below the previews, above the previews, to a left side from the previews, and to a right side from the previews.

5. The computing device of claim 1, wherein the formatting module is further configured to:
detect a scroll action on the selected preview, wherein a page of the document is displayed on the selected preview; and
replace the page of the document displayed on the selected preview with another page of the document.

6. The computing device of claim 1, wherein the formatting module is further configured to:
detect a scroll action that starts within the selected preview and ends within another preview from the previews; and
replace the selected preview on the UI of the display device with the other preview.

7. The computing device of claim 1, wherein the formatting module is further configured to:
detect a selection of another preview from the previews;
apply another semantic style associated with the other preview to the document; and
display the other preview on the UI of the display device.

8. The computing device of claim 7, wherein the formatting module is further configured to:
detect a customization action to modify the document; and
modify the other preview to match the customization action.

9. The computing device of claim 8, wherein the customization action includes one or more of: a font customization of the document, a spacing customization of the document, and a color customization of the document.

10. The computing device of claim 1, wherein the formatting module is further configured to:
detect a selection action to mark the selected preview as a favorite preview, wherein the selection action promotes use of the favorite preview in a future edit session.

11. The computing device of claim 1, wherein the formatting module is further configured to:
display the previews of the document as a slideshow presentation.

12. A method executed on a computing device for providing a semantic based design for a document, the method comprising:
generating previews of the document;
presenting the previews of the document on a user interface (UI) displayed on a display device;
detecting a selection of a preview from the previews;
applying a semantic style associated with the selected preview to the document, wherein the semantic style includes formatting configurations to be applied to the document;
in response to a detection of a save operation on the document, saving the semantic style associated with the selected preview; and
displaying a toolbar control in a position within a proximity to the previews, wherein the toolbar control includes toolbar commands.

13. The method of claim 12, further comprising:
generating another semantic style from attributes of an image within the document, wherein the attributes of the image include a predominant color within the image;
applying the other semantic style to the document in the selected preview; and
displaying the selected preview with the other semantic style in the UI of the display device.

14. The method of claim 12, further comprising:
detecting a formatting selection in response to an activation of a formatting control;
generating another semantic style based on the formatting selection;
applying the other semantic style to the document in the selected preview; and
displaying the selected preview with the other semantic style in the UI of the display device.

15. The method of claim 14, further comprising:
detecting a scroll action that starts within the selected preview and ends within the other preview, wherein the other preview displays the other semantic style; and
replacing the selected preview on the UI of the display device with the other preview.

16. The method of claim 12, further comprising:
generating the previews based on historical formatting selections associated with the document.

17. The method of claim 12, further comprising:
generating the previews based on historical formatting selections associated with one or more documents related to the document.

18. A computer-readable memory device with instructions stored thereon for providing a semantic based design for a document, the instructions comprising:
generating previews of the document;
presenting the previews of the document on a user interface (UI) displayed on a display device;
detecting a selection of a preview from the previews;
applying a semantic style associated with the selected preview to the document, wherein the semantic style includes formatting configurations to be applied to the document;
in response to a detection of a save operation on the document, saving the semantic style associated with the selected preview; and
displaying a toolbar control in a position within a proximity to the previews, wherein the toolbar control includes toolbar commands.

19. The computer-readable memory device of claim 18, wherein the instructions further comprise:
detecting a formatting selection in response to an activation of a formatting control;
generating another semantic style based on the formatting selection;
applying the other semantic style to the document in the selected preview;
displaying the selected preview with the other semantic style in the UI of the display device;
detecting a scroll action that starts within the selected preview and ends within the another preview, wherein the other preview displays the other semantic style; and
replacing the selected preview on the UI of the display device with the other preview.

20. The computer-readable memory device of claim 18, wherein the instructions further comprise:
detecting a selection of another preview from the previews;
applying another semantic style associated with the other preview to the document; and
displaying the other preview on the UI of the display device.
